(19) United States
(12) Patent Application Publication
(10) Pub. No.: US 2008/0278494 A1
(43) Pub. Date: Nov. 13, 2008

(54) SYSTEM AND METHOD FOR INFORMATION DISPLAY

(75) Inventors: Matthew L. Ginsberg, Eugene, OR (US); Erin Keenan, Eugene, OR (US)

Correspondence Address: FENWICK & WEST LLP, SILICON VALLEY CENTER, 801 CALIFORNIA STREET, MOUNTAIN VIEW, CA, 94041, US

(73) Assignee: On Time Systems Inc., Eugene, OR (US)

(21) Appl. No.: 11/747,877

(22) Filed: May 11, 2007

(51) Int. Cl. G06T 11/20

(52) U.S. Cl. 345/440

(57) ABSTRACT

N or more dimensions of information are presented on a conventional M-dimensional graph, where N>M, using a visual attribute type such as color to depict the additional dimensions of information. Each data input value comprised by the graph has additional values beyond those representing the M-dimensional aspects, and the visual attributes with which the data input value is presented on the graph is a function of these additional values. In one embodiment, a two-dimensional bar graph employs color to provide a visualization of the quality of a work schedule by depicting not only time and resource utilization, but also criticality of component work tasks.

### STATEMENT OF GOVERNMENT INTEREST

Portions of the present invention may have been made in conjunction with Government funding, and there may be certain rights to the Government.

### BACKGROUND

1. Field of Art

The present invention generally relates to data visualization, and more specifically, to data visualization using computer-generated graphs to optimize work scheduling for engineering projects such as ship construction.

2. Description of the Related Art

Two-dimensional graphs, such as bar and line graphs, have proven very effective for visualizing data in a wide variety of areas, such as those requiring work schedule optimization. For example, shipbuilding is a labor-intensive industry that requires relatively skilled and expensive labor, a major component of the overall cost of a ship. More effective labor utilization work schedules can greatly reduce the cost and increase the odds of successfully constructing a ship in a desired time frame. Some examples of scheduling applications in construction, manufacturing and even computer programming are provided in U.S. Patent Application No. 2005/0065826.

The feedback provided by a work schedule graph helps project managers assess the quality of their work schedules and evaluate whether and when task performance orders should be rethought. Similarly, graphical data about scheduling is of great utility for those in charge of hiring workers and allocating tasks for automobile assembly lines, for administrators of hospitals attempting to figure out how best to schedule doctors and nurses so as to accommodate the needs of patients, and for those planning construction schedules so as to meet milestone deadlines while containing cost. In these and similar areas, such graphical data assists planners, managers and executives in making decisions about scheduling so as to achieve mission-critical objectives such as achieving quality standards and optimizing with respect to time, cost, labor, and capacity. Conventional graphs used in product scheduling are typically in two physical dimensions (e.g., conventional Cartesian x and y coordinate graphs), and are limited to displaying the relationship between two variables, such as time and resource utilization level. Relationships of three or more variables are conventionally represented using other approaches, such as two-dimensional representations of three-dimensional relationships (e.g., surface plots, contour plots, block graphs) or sets of two-dimensional graphs. Such approaches are not readily comprehensible to the average user, and are thus of limited practical utility.

There have been previous attempts at supplementing a standard two-dimensional graph with additional information. Some systems added color to a graph to represent additional information, but only for limited cases where a given color is arbitrarily assigned to represent one of a set of discrete values. As an example, such a system might arbitrarily represent work schedule items performed by electricians in red, and items performed by plumbers in blue. However, such systems fail to address the problem of representing additional information when such additional information consists of an arbitrary number of values having an ordered relationship, such as a particular set of values associated with a continuous variable, and where the user desires to see a graphical representation of the relationship. Similarly, a certain type of two-dimensional bar graph known as a “stacked” bar graph is often used to indicate, for a variable in the z dimension, how many instances of a set of discrete z values are present. However, such graphs are not known to be used to represent continuous z variables.

Another example of a previous attempt with limited applicability is Marais, U.S. Pat. No. 7,015,912, which addressed the problem of representing data from a plurality of pie charts, each of which tracked a different information category, within the various bars of a single bar graph. Again, though such a technique allowed visually distinguishing the identity of the various discrete, unrelated components of the individual pie charts, it did not address the problems of visually representing the relationship of ordered values, as opposed to simply enumerating different pie chart categories via bars, or of representing changes in more than two variables.

Thus, there remains a need for a system and process to augment a conventional graph with additional information about other variables needed for making decisions to achieve effective scheduling of tasks in an engineering project, while still presenting a graph that is intuitive to the viewer and makes important information easy to see.

### SUMMARY

As disclosed herein, multivariate relationships are represented visually by augmenting conventional graph elements with additional visual characteristics. In one embodiment, color is used. More specifically, in a preferred embodiment for conveying x, y, and z values from a data source a bar graph includes bars that represent the measurements for a certain x-value, with each measurement having a size corresponding to its y-value and at least one additional visual attribute according to its z-value. In some embodiments, data comprised by a “measurement” may, but need not, be obtained solely by means of automatic data capture, such as the signals provided by a conventional transducer. In certain embodiments, the measurement may in whole or in part be calculated based upon existing data or be manually specified by a human user.

In one embodiment, color is a type of visual attribute used to represent the metric of criticality of a particular task in a project, thus augmenting the standard spatial attributes used to represent of the variables of time and resource utilization. In practice, such representation is effective for use in scheduling applications pertaining to large engineering projects, providing an intuitive visual indication of how well a given work schedule has allocated the various tasks across the available times. Thus, a set of such graphs, each corresponding to a different schedule, allows rapid visual comparison of the relative optimality of various possible schedules. This has particular practical application in areas such as shipbuilding, where resource utilization is heavy and the degree of criticality of a task is a vital factor in constructing a schedule which both minimizes cost and maximizes likelihood of successful completion. In other embodiments, metrics other than criticality can be represented, such as the cost of a task, or the ratio of actual time taken for a given task to the time initially allocated to it.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description and the appended claims, when taken in conjunction with the accompanying drawings, in which:

FIG. 1 is a flowchart illustrating the high-level steps performed, according to one embodiment.

FIG. 2 illustrates graphs generated according to one embodiment.

FIG. 3 is a high-level block diagram illustrating a computer system for implementing a preferred embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of the claimed invention.

### System Architecture

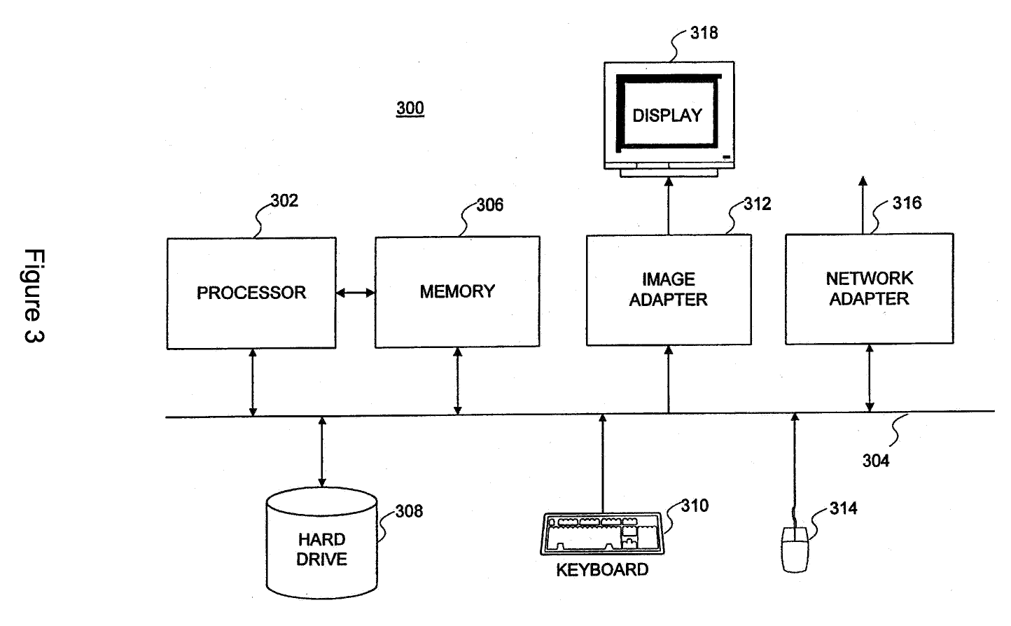

FIG. 3 is a high-level block diagram illustrating a computer system 300 for producing graphical representations as described herein. In a preferred embodiment, a conventional computer programmed for operation as described herein is used to implement computer system 300. Processor 302 is conventionally coupled to memory 306 and bus 304. For applications in which higher performance is required, multiple processors 302 are employed. Also coupled to the bus 304 are memory 306, storage device 308, keyboard 310, graphics adapter 312, pointing device 314, and network adapter 316. Display 318 is coupled to the graphics adapter 312.

In a typical embodiment, processor 302 is any general or specific purpose processor such as an INTEL 386 compatible central processing unit (CPU). Storage device 308 is any device capable of holding large amounts of data, like a hard drive, compact disk read-only memory (CD-ROM), digital versatile disk (DVD) or other removable storage device. Memory 306 holds instructions and data used by the processor 302. The pointing device 314, such as a mouse, track ball, light pen, touch-sensitive display, is used in combination with the keyboard 310 to input data into the computer system 300. The graphics adapter 312 displays images and other information on the display 318. The network adapter 316 couples the computer system 300 to the user's network environment, such as a local or wide area network (not shown). Also not shown is conventional input/output circuitry, such as transducers, to obtain measurements relating to the information to be displayed. In some embodiments, system 300 is used to collect such measurements and other data relating to information to be displayed. In other embodiments, other conventional mechanisms are used to collect such measurements and other data, and system 300 receives this input via any of network adapter 316, removable storage as referenced above, and input via keyboard 310.

A program for creating and displaying graphs according to one embodiment of the present invention is preferably stored on the storage device 308, loaded from memory 306, and executed on the processor 302. Alternatively, hardware or software modules are stored elsewhere within the computer system 300 for performing graphing actions as described herein.

The generated graphs are output to the display 318, and, as desired, to additional output devices and output formats (not shown), including, for example, printers, fax devices, and image or printer files. Additionally, if desired they are passed as input to other software processes, such as those for performing project scheduling or displaying Gantt charts.

### EXEMPLARY GRAPHS

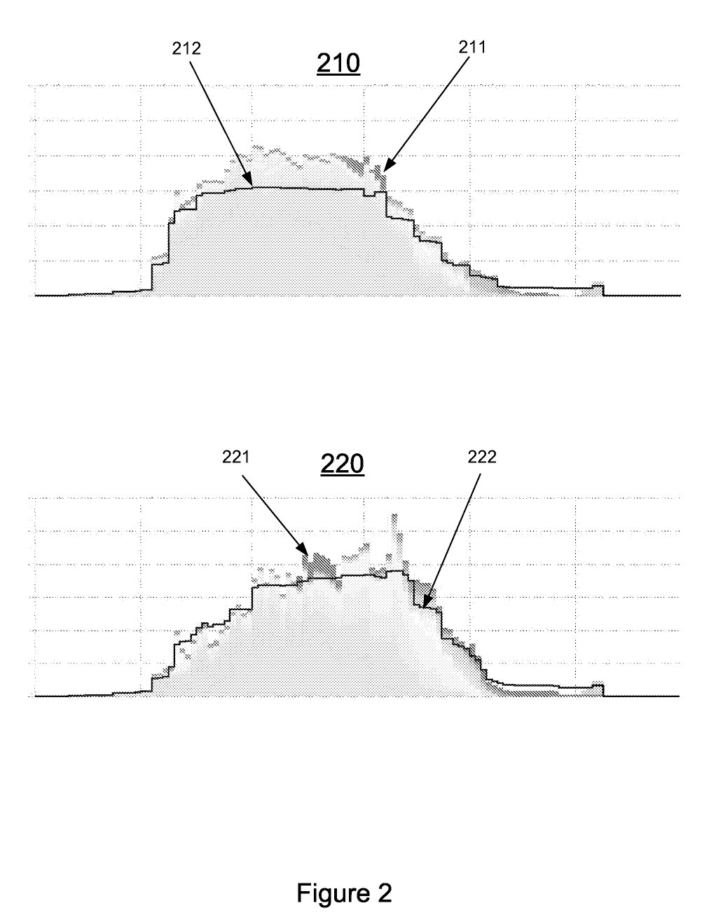

Referring now to FIG. 2, graphs produced in accordance with a preferred embodiment are illustrated, in which color is used to provide a third dimension of information on an otherwise conventional two-dimensional bar graph. Thus, of the three dimensions of data represented by the x, y, and z variables, two dimensions (i.e. the x and y variables) are used to generate the graph's conventional spatial attributes, and one dimension (i.e. the z variable) is used to generate the supplementary visual attribute of color.

The two exemplary graphs 210 and 220 depicted are specifically used to visualize work schedules, and thus the relevant variables to be represented include time, resource utilization of a task, and criticality of that task, though one of skill in the art would realize that other variables may equally be represented. In the particular instance shown in FIG. 2, two graphs 210 and 220 are provided for the purpose of allowing a user to determine certain advantages of an improved schedule (top graph 210) over an original schedule (bottom graph 220).

The exemplary graphs 210 and 220 contain a number of bars, each bar corresponding to a number of measurements representing tasks. Each task has a 3-tuple of data associated with it, representing the task time, task resource utilization, and task criticality. Such values may be considered analogous to the x, y, and z coordinates of a three-dimensional graph. A task scheduled at a given time is placed at the same x-value, and thus in the same bar, as other tasks scheduled for that time. Such tasks are sequentially “stacked” in a visual representation within their respective bars, with an order corresponding to their respective criticality z-values, and with their relative sizes represented by their resource utilization y-values. In the particular graphs 210 and 220, the most critical tasks 211 and 221 are placed at the “top” of the bars (the greatest values on the y-axis), and the least critical at the bottom. Criticality in these exemplary graphs is illustrated by the use of varying color, the most critical tasks being indicated in a preferred embodiment in red, and the least critical in green; tasks with intermediate criticality values are assigned a color that blends red and green in proportion to their criticality values. In FIG. 2, the color red is represented by dark shading toward the top of various bars; yellow is light shading in the middle of the bars and green is intermediate shading at the bottom of the bars. Thus, the x-axis represents time, the y-axis represents overall resource utilization, and color denotes a measure of criticality at any particular time.

The exemplary graphs 210 and 220 have a number of benefits compared to conventional two-dimensional bar graphs. First, by supplementing standard two-dimensional information with the visual attribute of color, they convey more information than just resource utilization as a function of time—they rapidly and intuitively convey the criticality of the resource utilization, as well. Second, and more specifically, by visually ordering the tasks according to their criticality values, tasks with similar importance are grouped together. This grouping allows quick visual identification of the time periods in which the most critical tasks are taking place, and further allows the user to select, e.g. via mouse, regions of the graph that are of interest. The user can then obtain further information based upon the tasks within these regions, such as by visually zooming in or by invoking other tools to analyze the selected tasks. Additionally, note that the introduction of color does not generally impact other graphical augmentation techniques, such as projected manpower lines 212 and 222, which depict the manpower projected to be available during the project.

As noted above, the two exemplary graphs of FIG. 2 represent two alternative schedules for accomplishing an engineering project and allowing easy visual determination of which schedule is closer to optimal. The lower graph 220 represents an original schedule, and the upper graph 210 represents a schedule that has been modified to reduce the “criticality” of the tasks in question, i.e. how much a given task could be delayed before the overall delivery schedule is affected. It is readily apparent to the viewer that this modification has been successful and that the upper graph 210 has lower overall criticality, represented by the lesser amount of red tasks. In practice, the criticality of a task is based on various factors. Some tasks are inherently critical, such as those that can only be performed by an extremely scarce resource such as a “super-specialist” contractor who is not fungible and must be scheduled months in advance. Other tasks are critical by virtue of where they happen to fall in the overall schedule. For instance, a certain type of coating may need to be applied to a weld within just a few hours of the weld having been made, but the coating must then be allowed to cure for several days before being painted. Alternatively, one process may use an adhesive that is flammable until cured, thus precluding other processes that involve heat until the curing is complete. Different scheduling techniques exist that can minimize overall criticality for a project, and the upper graph 210 of FIG. 2 illustrates a situation where such criticality is significantly reduced compared to schedule depicted in the lower graph 220.

Comparing graphs 210 and 220, it is apparent that the large region of critical tasks 221 from the original schedule (lower graph 220) has been reduced both in size and intensity, apparently with some offsetting criticality arising in earlier times when there is more potential slack in their execution, thereby increasing schedule flexibility. Thus, a user can quickly tell from visual inspection of the graph coloring that the optimized schedule will be more likely to execute successfully due to the lesser number of “hot spots.”

One of skill in the art would recognize that the illustrated graphs are merely exemplary, that such graphs have many other applications than scheduling as discussed above, and that the types of measurements (or variables) that may be represented are not limited to time, resource utilization, and criticality. Nor is color gradation the only method of visualizing “extra-dimensional” information. The discussion below sets forth a fuller description of preferred embodiments.

### Method of Operation

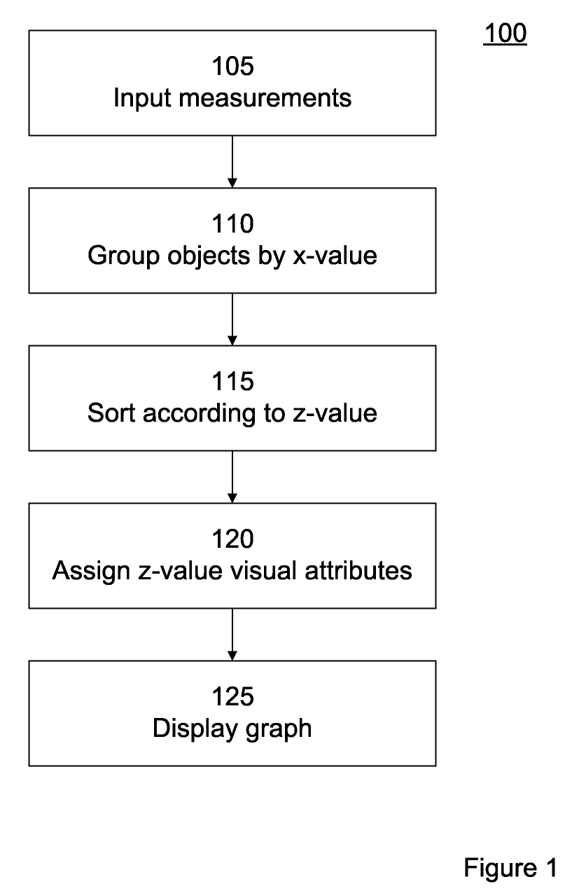

FIG. 1 illustrates, in flowchart form, one example of steps taken in order to produce a graph according to a preferred embodiment.

The first step is to input 105 a set of measurements that constitute the data to be graphed. This is accomplished conventionally according to the location of the data, such as reading data from local storage, e.g. a hard disk, or receiving data from a remote location via the network adapter 316. The input measurement data itself may have been created manually by human operators, or by automatic methods, such as through measurements obtained by a conventional transducer. In some applications, the measurements are actual, while in others they are projected. Each measurement has a set of three or more values, denoted here as x, y, and z values. It is appreciated, however, that though a preferred embodiment uses the x, y, and z coordinates of a Cartesian coordinate system, other embodiments can equally employ other coordinate systems.

Subsequently, the set of measurements to be graphed is grouped 110 according to x value, each group representing an individual bar of the graph. Depending on the attributes of the data to be graphed and what would be preferable for a user, a separate group may be formed for every distinct x value, or a group may include all measurements with x values within a given range.

Next, each group is sorted 115 according to the z values of the objects of that group. The sort may be in either ascending or descending order of z-value as may be appropriate for a given application, since both will provide a sorted ordering and thus will make for easy visual inspection when graphed. This sorted ordering enables the subsequent determination of correspondingly-ordered visual attributes for measurements with a continuous z-variable.

Next, visual attributes are assigned 120 to measurements based on their respective z-values, the visual attributes ordered in a manner corresponding to the order of the z-values which they represent. As discussed below, a number of visual attribute types are employed in different embodiments, some more appropriate to certain situations than to others.

Color is one very effective visual attribute type by means of which to display additional information. Colors are assigned to measurements in different manners in different embodiments. In one “step function” embodiment, the range of possible z-values is divided into two or more distinct intervals and a distinct color from a set of ordered colors is assigned to each interval, with all the z-values within that interval being assigned the same color. For example, in one exemplary embodiment, if the possible z-values range from 1 to 99 and the colors range from green to red, then the range is divided into three intervals, one interval comprising values from 1 to 33 and being represented by 100% green, another from 34 to 66 and being represented by a color that is a blend of 50% green and 50% red, and another from 67 to 99 and being represented by 100% red. Additionally, note that if the range of possible z-values is not bounded, then high and low cutoff values may be chosen, and z-values falling outside the interval formed by the high and low cutoff values may be clamped to the closer cutoff value.

Further visual richness and added information are conveyed by embodiments in which colors are assigned to each individual value, rather than to all values in a given range of z-values. The exemplary graphs of FIG. 2 illustrate one such embodiment in which colors are chosen for each individual measurement.

The particular color used to represent a given z-value may be determined according to various methods in different embodiments. In the embodiment of the exemplary graphs of FIG. 2, a linear color transition is the method employed, lower values being assigned greener colors, and higher values being assigned redder colors. More specifically, the color green is associated with the lower “end” of the z-value range, and the color red with the upper end. Then, based on the z-value of a measurement a color is chosen for that measurement as a linear blend of red and green. For example, assume that the lowest z-value is 10, and the highest z-value is 110. Then a measurement with z-value 50 is 50−10=40 units along the continuum from green to red that spans 110−10=100 units; thus, it is 40/100=40% of the way from green to red, and its color value is accordingly 40% red and 60% green. Note that such a blending of colors is possible by virtue of the fact that the z-values of the example can be ordered and assigned a value relative to the highest and lowest z-values.

A particular visual attribute type, such as a color generated through linear blending, may be thought of as a visual attribute function, taking an input value (such as a criticality measure) and generating an output value (such as a color) used for augmenting the standard spatial information that constitutes a traditional graph.

In one embodiment, the color chosen for a given measurement is applied uniformly across the visual region representing that measurement. In another embodiment, the colors vary across the visual region, depending on the colors of the adjacent measurements. For example, linear blending might be employed to shade the determined color of one measurement gradually towards that of its neighbor as it approaches the neighbor. The former approach is useful for precisely delineating the visual boundaries of the measurements in cases where such measurements should be individually distinguishable, and the latter approach for emphasizing the holistic, continuous nature of the measurements and avoiding the distraction of potentially sharp changes.

Note that the function used to determine the color for a given measurement need not produce a linear color transition, and one of skill in the art would realize that other functions are possible for choosing the color to represent a particular measurement. For example, in one embodiment, the function is quadratic, rather than linear. In another embodiment, the function differentiates placement of measurements within each interval such that, for instance, color gradations may be sharper where measurements are clustered near an edge of the range and more gradual where measurements are further away from such edges.

In some embodiments, there is not precisely one z-value range over which a color is determined, but many separate ones, each with its own method of determining color. One such embodiment includes a low range varying between red and blue, and a high range varying between blue and yellow. In such an embodiment, measurements with z values in the low range would be assigned a color that is some blend of red and blue, and those with z values in the high range some blend of blue and yellow, according to some desired color blending function, e.g. a linear function. Thus, each individual z-value range has its own separate ordering for the specific visual attribute values of the color visual attribute type.

In some embodiments, the values chosen to represent the “endpoints” (e.g. the high and low ends referenced in the above discussion of linear blending) of a given z-interval range are determined so as to be the same for every bar in the graph. In other embodiments, there are separate endpoint values for each bar. This leads to different visual effects. For example, if the former method is employed and interval boundaries of 1 and 99 are assigned, then a bar containing measurements with z-values 49, 50, and 51 appears almost uniformly colored, since the variations in the z-values are so small relative to the size of the interval between the interval boundaries. If the latter method is employed and tighter interval boundaries of 48 and 52 are chosen to reflect the tight spacing of the measurements in that particular bar, then the measurements for that bar are assigned much more distinctive colors.

Other embodiments vary the color not through the specific R, G, B color components, but through the intensity, saturation, or opacity of the color. Still other embodiments accomplish the conveying of information beyond that of a standard two-dimensional graph, not necessarily through the use of color, but through other visual indications, such as through patterns, textures and shadows. Note that, as with colors, the degrees of these other visual indications can be ordered: for example, the density of a pattern can be varied. In another embodiment, combinations of color, patterns, shadowing, horizontal shading, and other visual indications are formed in order to convey multiple levels of additional information.

Still other embodiments augment the graph with visual attributes based on multiple additional variables, rather than just one. Generally, if the additional variables to be represented by visual indications are z₁, z₂, . . . , zₖ, and if each zᵢ can be ordered, then a monotone function (i.e. a function ƒ such that, for 2 values x and y of zᵢ, x<y→ƒ(x)<ƒ(y)) is used to provide a visual indication of values for each zᵢ, with a different visual indication technique, such as gradation of color or intensity of shadow, being used for each variable. Alternatively, if an entire tuple of variables can be ordered, then the monotone function can provide the appropriate visual indication for the tuple as a whole, rather than for each individual variable within it.

Finally, the measurements are output so as to display 125 the bar graph. This involves displaying the individual data input values in their respective x-value-based bars, sequentially arranged according to their z-values, with sizes corresponding to their y-values, and with further visual attributes, e.g. those based on color, determined according to their z-values. If the measurements do not have corresponding y-values, then each object may be assigned the same y-value, e.g. 1 unit. In one embodiment, the orientation of the bars is not critical and the bars may be arranged vertically, horizontally, or in a direction not parallel to either of the axes; the bars need not be precisely parallel with each other, either. Further, the bars need not be completely non-overlapping, nor need they have any particular width. Freedom from these constraints permits further measurements or attributes of interest to be displayed through variation of these parameters.

One of skill in the art would realize that the invention is not limited to providing output to a display such as a monitor, but can display a graph by any action that results, directly or proximately, in a visual image, such as outputting to a printer, to a fax, to an image file, or to a file containing printer description language data. Further, the type of graph is not limited to bar graphs, but includes any type of graph for which the addition of visual attributes such as those described herein can be used to provide a user with additional information. Additionally, as noted above, the invention is not limited to instances where the visual attributes are based on a single variable; rather, the visual attributes may be based on a plurality of variables not already represented in the graph's spatial attributes.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, the words “a” or “an” are employed to describe elements and components of the invention. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for outputting n-dimensional graphs representing the relationships of more than n variables through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. An engineering project management system, comprising:
an input subsystem, adapted to convert a set of measurements into n-dimensional data input values; and
an output subsystem, operatively connected to the input system and producing output based upon the n-dimensional data input values, wherein the output includes a graph, the graph having:
spatial attributes corresponding to m dimensions of the n-dimensional data input values, where m is less than n, and
visual attributes corresponding to a subset of the (n−m) dimensions not represented in the spatial attributes of the graph, the subset including ordered values.

2. The system of claim 1, wherein the n-dimensional data input values include actual and projected values.

3. The system of claim 1, wherein the n-dimensional data input values include task time, task resource utilization and task criticality, wherein the spatial data corresponds to task time and task resource utilization, and wherein the visual attribute is a color corresponding to task criticality.

4. The system of claim 1, wherein the output subsystem generates the visual attributes using a visual attribute function, wherein the visual attribute function is monotone and operates on the ordered values of the subset.

5. The system of claim 4, wherein the visual attribute function performs a linear blending of a given two colors.

6. The system of claim 4, wherein the visual attribute function performs at least one of: varying R, G, B values of a color, varying an intensity of a color, varying an opacity of a color, varying density of a pattern, and varying a degree of shadow.

7. A method for data visualization in an engineering project management system, comprising:
converting a set of measurements into n-dimensional data input values; and
producing output based upon the n-dimensional data input values, wherein the output includes a graph, the graph having:
spatial attributes corresponding to m dimensions of the n-dimensional data input values, where m is less than n, and
visual attributes corresponding to a subset of the (n−m) dimensions not represented in the spatial attributes of the graph, the subset including ordered values.

8. The method of claim 7, wherein the n-dimensional data input values include actual and projected values.

9. The method of claim 7, wherein the n-dimensional data input values include task time, task resource utilization and task criticality, wherein the spatial data corresponds to task time and task resource utilization, and wherein the visual attribute is a color corresponding to task criticality.

10. The method of claim 7, wherein the visual attributes are generated by a visual attribute function, wherein the visual attribute function is monotone and operates on the ordered values of the subset.

11. The method of claim 10, wherein the visual attribute function performs a linear blending of a given two colors.

12. The method of claim 10, wherein the visual attribute function performs at least one of: varying RGB values of a color, varying an intensity of a color, varying an opacity of a color, varying density of a pattern, and varying a degree of shadow.

13. A tangible computer readable storage medium storing a computer program executable by a processor for performing data visualization in an engineering project management system, the actions of the computer program comprising:
converting a set of measurements into n-dimensional data input values; and
producing output based upon the n-dimensional data input values, wherein the output includes a graph, the graph having:
spatial attributes corresponding to m dimensions of the n-dimensional data input values, where m is less than n, and
visual attributes corresponding to a subset of the (n−m) dimensions not represented in the spatial attributes of the graph, the subset including ordered values.

14. The computer readable storage medium of claim 13, wherein the n-dimensional data input values include actual and projected values.

15. The computer readable storage medium of claim 13, wherein the n-dimensional data input values include task time, task resource utilization and task criticality, wherein the spatial data corresponds to task time and task resource utilization, and wherein the visual attribute is a color corresponding to task criticality.

16. The computer readable storage medium of claim 13, wherein the visual attributes are generated by a visual attribute function, wherein the visual attribute function is monotone and operates on the ordered values of the subset.

17. The computer readable storage medium of claim 16, wherein the visual attribute function performs a linear blending of a given two colors.

18. The computer readable storage medium of claim 16, wherein the visual attribute function performs at least one of: varying R, G, B values of a color, varying an intensity of a color, varying an opacity of a color, varying density of a pattern, and varying a degree of shadow.

19. A method for displaying a set of measurements, comprising:
converting the set of measurements into n-dimensional data input values including task time, task resource utilization and task criticality, the n-dimensional data input values including actual and projected values; and
producing output based upon the n-dimensional data input values, wherein the output includes a graph, the graph having:
spatial attributes corresponding to m dimensions of the n-dimensional data input values, where m is less than n, and
visual attributes corresponding to a subset of the (n−m) dimensions not represented in the spatial attributes of the graph, wherein:
the subset includes ordered values,
the visual attributes are generated by a visual attribute function, wherein the visual attribute function is monotone, operates on the ordered values of the subset, and performs at least one of: linear blending of a given two colors, varying RGB values of a color, varying an intensity of a color, varying an opacity of a color, varying density of a pattern, and varying a degree of shadow.
